(19) United States
(12) Patent Application Publication
(10) Pub. No.: US 2025/0062089 A1
(43) Pub. Date: Feb. 20, 2025

(54) KEYBOARD WITH BUFFER STRUCTURE

(71) Applicant: SOLID YEAR CO., LTD., NEW TAIPEI CITY (TW)

(72) Inventors: Li-Yang CHIANG, NEW TAIPEI CITY (TW); Chi-Feng LIU, NEW TAIPEI CITY (TW)

(73) Assignee: SOLID YEAR CO., LTD., NEW TAIPEI CITY (TW)

(21) Appl. No.: 18/804,642

(22) Filed: Aug. 14, 2024

Related U.S. Application Data
(60) Provisional application No. 63/532,469, filed on Aug. 14, 2023.

(51) Int. Cl. H01H 13/86; H01H 13/14

(52) U.S. Cl. CPC H01H 13/86; H01H 13/14

(57) ABSTRACT

A keyboard includes a base, a key module, and a buffer unit. The base has a bottom wall and an inner periphery wall connected to the bottom wall. The key module is disposed in the base and has a printed circuit board assembly. The buffer unit is disposed in the base and includes a cantilever with a top end connected to the bottom surface of the printed circuit board assembly and a bottom end spaced from the bottom wall of the base, and a torsion spring sleeved on the cantilever and having two end portions abutted against the bottom wall of the base and the inner periphery wall of the base, respectively. Therefore, the keyboard of the present invention utilizes coordination of the cantilever and the torsion spring to provide excellent support, thus maintaining a good keypress feel while effectively eliminating noise and cushioning impact force.

### BACKGROUND OF THE INVENTION

### 1. Field of the Invention

The present invention relates to keyboards and more particularly, to a keyboard that has a buffer structure.

### 2. Description of the Related Art

Generally, the movement structure of a computer key can be divided into two types, i.e. mechanical type and membrane type, in which the key base is directly collided by the key cap, which easily generates rather annoying noise when in use, and the noise can affect other people around, so that the computer key cannot be used in a place where silence is needed, such as a library.

In order to solve the above problems, the keycap disclosed in CN 208460630 has a notch at each of the four ribs, and a noise reduction rubber ring is disposed at each of the four notches, so as to provide noise reduction effect. In the aforesaid patent, when the key cap is pressed by an external force, the noise reduction rubber ring immediately generates a buffer when contacting the key cap cover, and thus the stroke of the key is reduced, which may affect the pressing feeling of the key.

In addition, the keycap disclosed in TW 201501155 has a body and a buffer member. The buffer member is disposed on a side of the body opposite to the contact surface, and when the shaft element is located at the moving position, the buffer member is abutted against the contact surface and generates elastic deformation corresponding to the contact surface. In the aforesaid patent, when the key cap is pressed by an external force, the buffer member immediately generates a buffer when contacting the contact surface, and the stroke of the key is reduced, which affects the pressing feeling of the key.

### SUMMARY OF THE INVENTION

It is one objective of the present invention to provide a keyboard, which has excellent support to maintain a good keypress feel, effectively eliminate noise, and cushion impact force.

To attain the above objective, the keyboard of the present invention comprises a base, a key module, a top cover, and a buffer unit. The base has a bottom wall and an inner periphery wall connected to an outer periphery of the bottom wall to form an accommodation space with the bottom wall. The key module is disposed in the accommodation space of the base and has a printed circuit board assembly and a plurality of keys connected to the printed circuit board assembly. The top cover is mounted on the base and has a plurality of hollow areas to expose the keys. The buffer unit is disposed in the accommodation space of the base and includes a cantilever and a torsion spring. The cantilever has a support portion connected to a bottom surface of the printed circuit board assembly, an inclined extension arm having a top end connected to the support portion, and a shaft portion connected to a bottom end of the inclined extension arm and spaced from the bottom wall of the base. The torsion spring is sleeved on the shaft portion and having two end portions. One of the end portions is abutted against the bottom wall of the base and the other of the end portions is abutted against the inner periphery wall of the base.

It can be seen from the above that the keyboard of the present invention uses the combination of the cantilever and the torsion spring to provide excellent support, thus maintaining a good keypress feel. At the same time, this configuration effectively eliminates noise generated during keypresses and cushions the impact force on the keys, thereby extending the keyboard's lifespan.

Preferably, the base further includes a stand plate connected to a top surface of the bottom wall, and a shaft portion connected to one lateral side of the stand plate. The buffer unit further includes another torsion spring sleeved on the shaft portion of the base and having two end portions abutted against the bottom wall of the base and the bottom surface of the printed circuit board assembly, respectively. By utilizing the additional torsion spring, the keyboard of the present invention achieves more balanced and stable support and cushioning effects at both the left and right ends.

Preferably, a buffer pad is placed on the top surface of the printed circuit board assembly, and a support plate is placed on the top surface of the buffer pad. The support plate, the buffer pad, and the printed circuit board assembly are fixed together though a special-shaped buffer element. By using the special-shaped buffer element, support and cushioning effects are provided.

Preferably, the base has a fixed column connected to the bottom wall and provided with a screw hole. The printed circuit board assembly is screwed to the base by using a screw inserted into a fixed hole of the printed circuit board assembly and screwed to the screw hole of the fixed column of the base. A conical spring or special-shaped buffer element can be sleeved on the fixed column to provide support and cushioning effects.

Preferably, the base has an upright column with a bottom end connected to the bottom wall. A conical spring or special-shaped buffer element can be disposed in a receiving trough of the upright column of the base to provide support and cushioning effects. In addition, a central column extends upwards from the bottom surface of the receiving trough. The central column is coaxial with the upright column and penetrated into the conical spring or the special-shaped buffer element to provide a support effect for the conical spring.

Other advantages and features of the present invention will be fully understood by reference to the following specification in conjunction with the accompanying drawings, in which like reference signs denote like components of structure.

### BRIEF DESCRIPTION OF THE DRAWINGS

FIG. 1 is a perspective view of a keyboard of a first embodiment of the present invention.

FIG. 2 is a partially exploded view of the keyboard of the first embodiment of the present invention.

FIG. 3 is an exploded view of the key module provided by the keyboard of the first embodiment the present invention.

FIG. 4 is an exploded view of the base and the buffer unit provided by the keyboard of first embodiment of the present invention.

FIG. 5 is a partially sectional view of the keyboard of the first embodiment of the present invention.

FIG. 6 is another partially sectional view of the keyboard of the first embodiment of the present invention.

FIG. 7 is an assembled sectional view of the base and the special-shaped buffer element provided by the keyboard of the first embodiment of the present invention.

FIG. 8 is an assembled sectional view of the base and the conical provided by the keyboard of the first embodiment of the present invention.

FIG. 9 is an assembled sectional view of the base and the special-shaped buffer element provided by the keyboard of a second embodiment of the present invention.

FIG. 10 is an assembled sectional view of the base and the conical provided by the keyboard of the second embodiment of the present invention.

FIG. 11 is an assembled sectional view of the base and the special-shaped buffer element provided by the keyboard of a third embodiment of the present invention.

FIG. 12 is an assembled sectional view of the base and the conical provided by the keyboard of the third embodiment of the present invention.

FIG. 13 is a partially exploded view of the keyboard of a fourth embodiment of the present invention.

FIG. 14 is an assembled sectional view of FIG. 13.

FIG. 15 is a partially exploded view of the keyboard of a fifth embodiment of the present invention.

FIG. 16 is an assembled sectional view of FIG. 15.

### DETAILED DESCRIPTION OF THE INVENTION

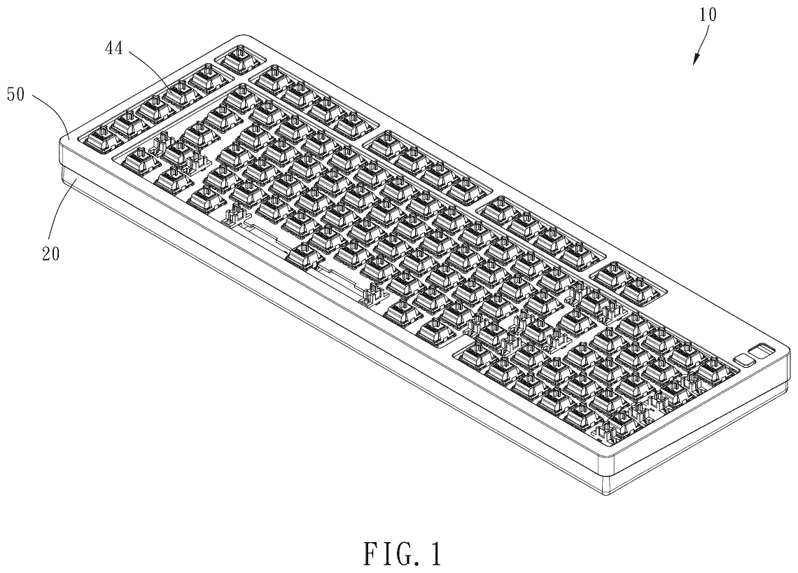

Referring to FIGS. 1-4, a keyboard 10 of a first embodiment of the present invention comprises a base 20, a key module 40, a top cover, 50, and a buffer unit 60.

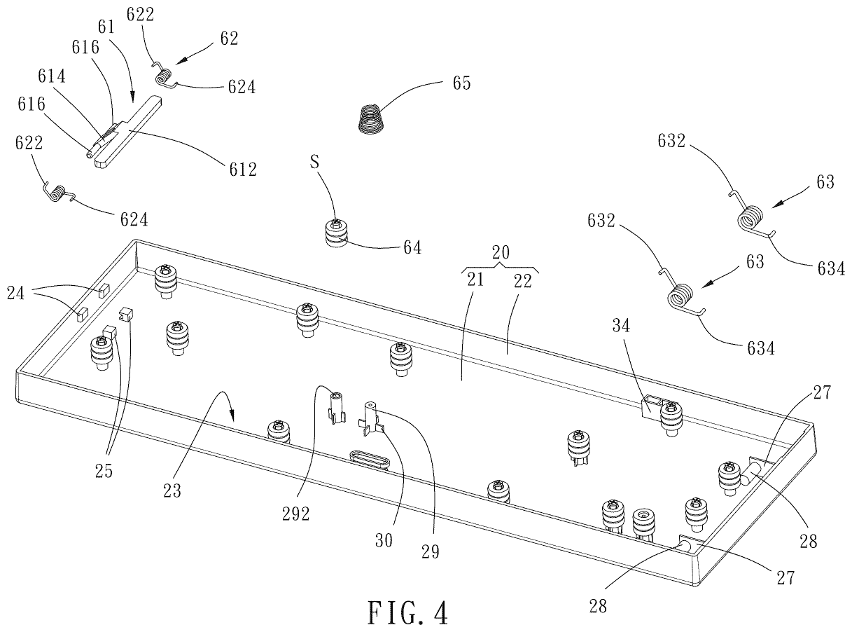

The base 20 includes a bottom wall 21 and an inner periphery wall 22. As shown in FIG. 4, the inner periphery wall 22 is connected to the outer periphery of the bottom wall 21 to form an accommodation space 23 with an upward-facing opening. The base 20 further includes two upper stops 24 connected to the left side of the inner periphery wall 22, two left stops 25 connected to the left end of the top surface of the bottom wall 21, two right stops 26 connected to the right end of the top surface of the bottom wall 21 (as shown in FIG. 6), two stand plates 27 connected to the right end of the top surface of the bottom wall 27 and arranged in a staggered manner with the two right stops 26, and two shaft portions 28 connected to the front sides of the two stand plates 27, respectively. In addition, the base 20 further includes a plurality of fixed columns 29 and a plurality of wings 30. The bottom ends of the fixed columns 29 are connected to the top surface of the bottom wall 21, and the fixed columns 29 each have a screw hole 292. The wings 30 are connected in groups of three to the top surface of the bottom wall 21 and the outer peripheral surface of the fixed column 29, and the wings 30 are arranged at equal intervals relative to the fixed column 29.

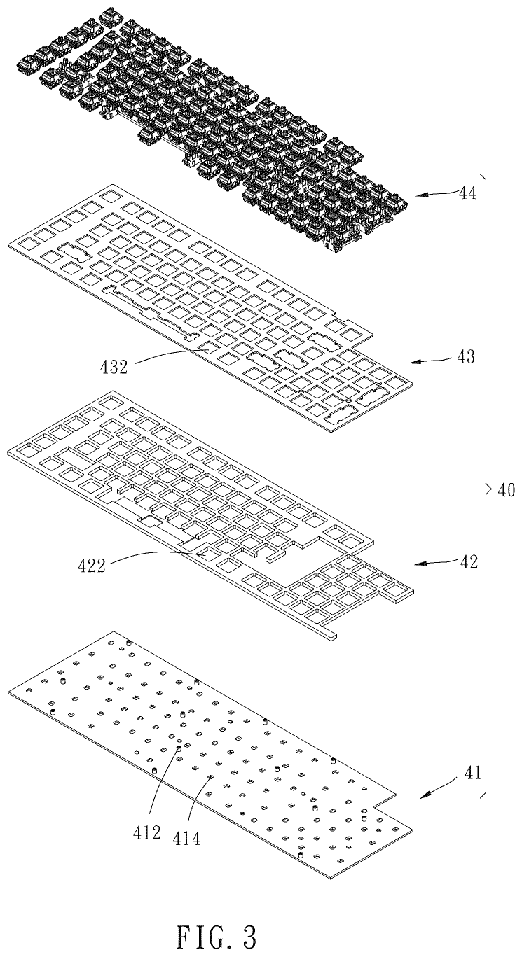

As shown in FIG. 3, the key module 40 is disposed in the accommodation space 23 of the base 20, including a printed circuit board assembly 41, a buffer pad 42, a support plate 43, and a plurality of keys 44. The printed circuit board assembly 41 has a plurality of fixed holes 412 and a plurality of key mounting holes 414. Multiple screws S are penetrated into the fixed holes 412 of the printed circuit board assembly 41 and screwed to the screw holes 414 of the base 20 so as to fix the printed circuit board assembly 41 and the base 20 together. The buffer pad 42 is placed on the top surface of the printed circuit board assembly 41 and has a plurality of lower positioning holes 422 corresponding to the key mounting holes 414 of the printed circuit board assembly 41 in a one-to-one manner. The support plate 43 is placed on the top surface of the buffer pad 42 and has a plurality of upper positioning holes 432 corresponding to the lower positioning holes 422 of the buffer pad 42 in a one-to-one manner. The keys 44 are positioned in the upper positioning holes 432 and the lower positioning holes 422 and installed in the key mounting holes 414 in a one-to-one manner, so that the keys 44 are connected to the printed circuit board assembly 41.

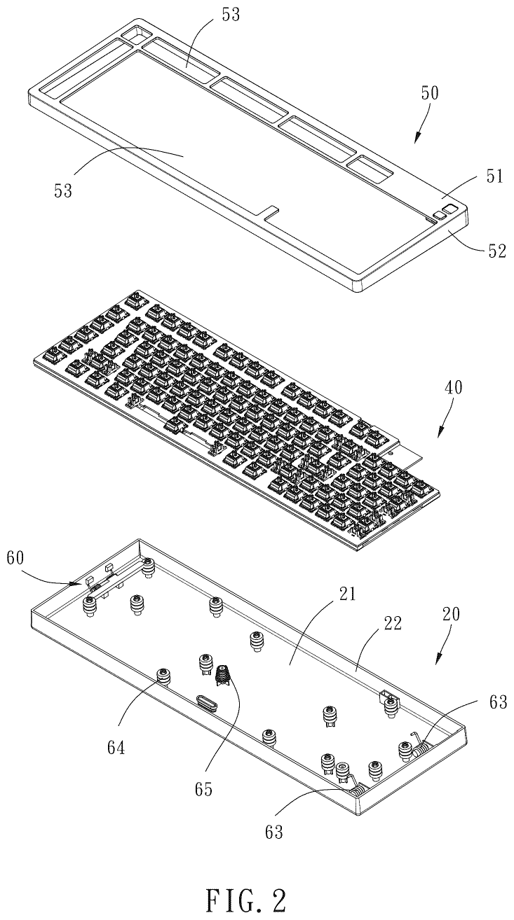

The top cover 50 has a top plate 51 and an outer periphery wall 52. As shown in FIG. 2, the outer periphery wall 52 is connected to the outer periphery of the top plate 51 and attached to the inner periphery wall 22 of the base 20, such that the base 20 is covered by the top cover 50. Additionally, the top plate 51 has multiple hollow areas 53 of different sizes. These hollow areas 53 allow the keys 44 to be exposed for enabling the user to press them.

As shown in FIG. 4, in this embodiment, the buffer unit 60 includes a cantilever 61, two first torsion springs 62, two second torsion springs 63, a plurality of special-shaped buffer elements 64, and a plurality of conical springs 65.

The cantilever 61 has a support portion 612, an inclined extension arm 614, and two shaft portions 616. The support portion 612 is connected to the bottom surface of the printed circuit board assembly 41, and the support portion 612 has an extending direction parallel to the width direction of the printed circuit board assembly 41. The top end of the inclined extension arm 614 is connected to the support portion 612, and the front and rear sides of the bottom end of the inclined extension arm 614 are connected to the shaft portions 616, respectively. Further, the bottom end of the inclined extension arm 614 maintains a certain distance from the bottom wall 21 of the base 20 without contacting it.

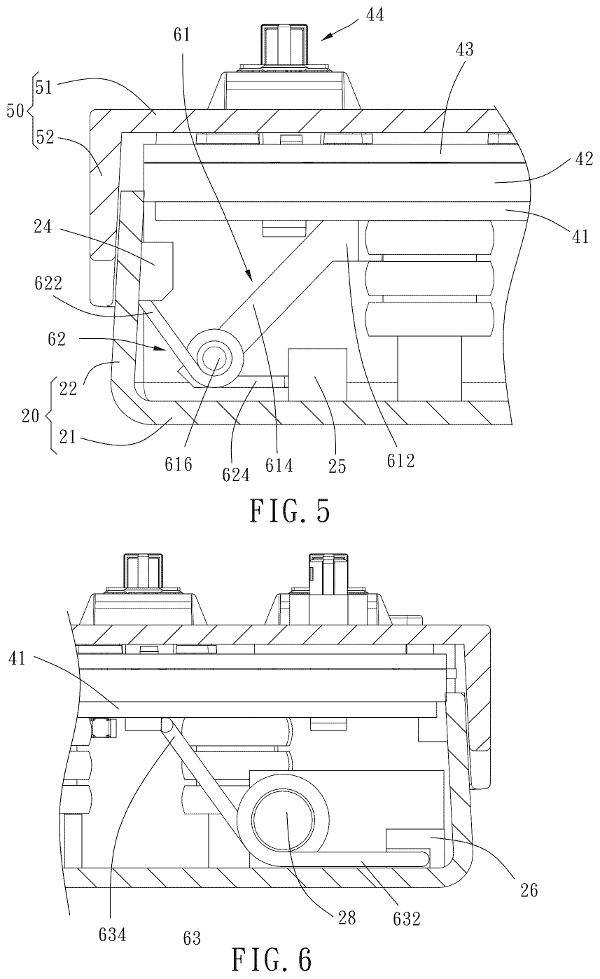

As shown in FIG. 5, the first torsion springs 62 are sleeved on the shaft portions 616 of the cantilever 61. The first torsion springs 62 each have two end portions 622, 624. The end portion 622 is engaged with the upper stops 24 of the base 20, and the other end portion 624 is engaged with the left stops 25 of the base 20. However, in fact, the number of the first torsion spring 62 can be set to at least one according to actual needs.

As shown in FIG. 6, the second torsion springs 63 are sleeved on the shaft portions 28 of the base 20. The second torsion springs 62 each have two end portions 632, 634. The end portion 632 is engaged with the right stops 24 of the base 20, and the other end portion 634 is abutted against the bottom surface of the printed circuit board assembly 41. However, in fact, the number of the second torsion spring 63 can be set to at least one according to actual needs.

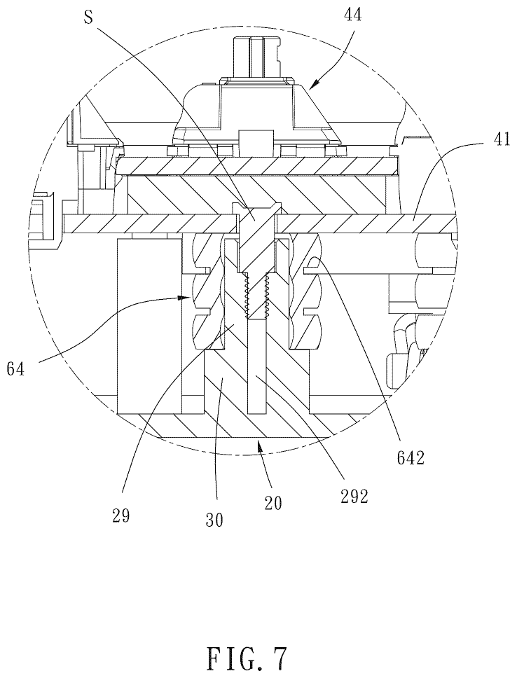

As shown in FIG. 7, the special-shaped buffer element 64 is sleeved on the fixed column 29 of the base 20, and the special-shaped buffer element 64 uses its top and bottom ends to abut against the bottom surface of the printed circuit board assembly 41 and the wings 30, respectively. In this embodiment, the special-shaped buffer element 64 is a hollow cylindrical body made of rubber material. The outer surface of the special-shaped buffer element 64 has a plurality of annular folds 642 arranged at equal intervals, which increase the deformation of the special-shaped buffer element 64 under pressure through these annular folds 642. It should be supplemented that the structure of the special-shaped buffer element 64 can be changed according to actual needs and is not limited to the hollow cylinder. In addition, the number of the special-shaped buffer element 64 can be increased or decreased according to actual needs. The special-shaped buffer element 64 can even be omitted.

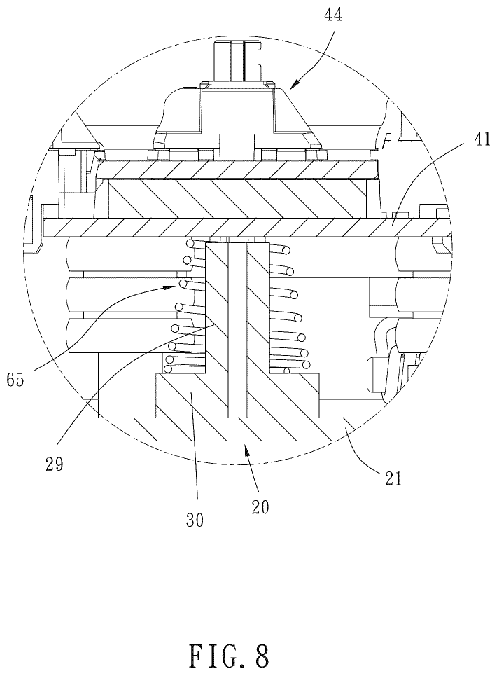

As shown in FIG. 8, the conical spring 65 is sleeved on another fixed column 29 of the base 20, and the conical spring 65 uses its top and bottom ends to abut against the bottom surface of the printed circuit board assembly 41 and the wings 30, respectively. Further, the conical spring 65 has a diameter increasing gradually from the printed circuit board assembly 41 to the bottom wall 21. It should be supplemented that the number of the conical spring 65 can be increased or decreased according to actual needs, or even omitted.

It can be seen from the above that the keyboard 10 of the present invention uses the combination of the cantilever 61, the first torsion spring 62, and the second torsion spring 63 and the assistance of the special-shaped buffer element 64 and the conical spring 65 to provide excellent support and recovery force for the keys 44, thus providing the user with an excellent pressing feel. At the same time, this configuration can effectively buffer the striking force on the keys 44 to achieve the effects of eliminating abnormal noise and extending service life.

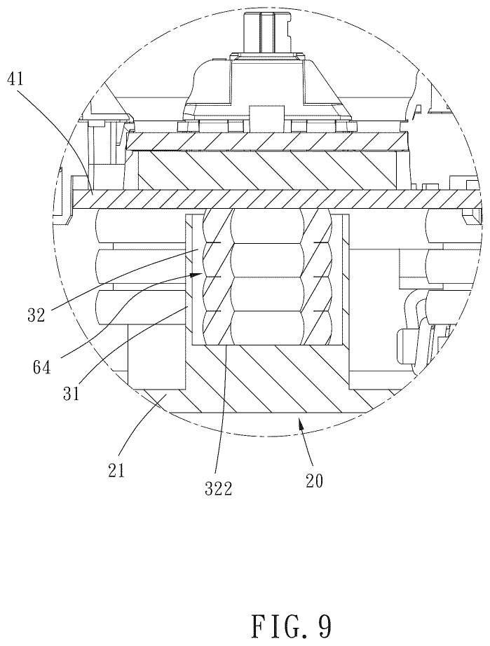

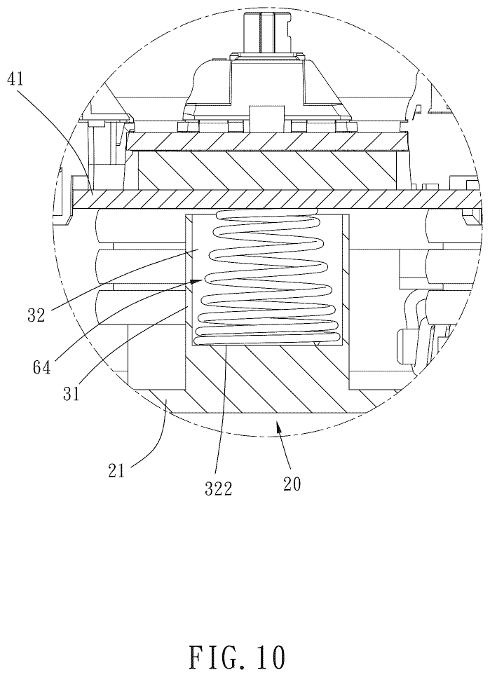

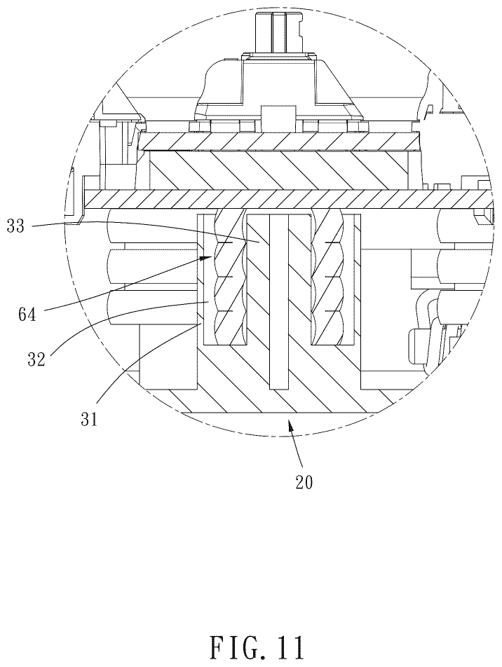

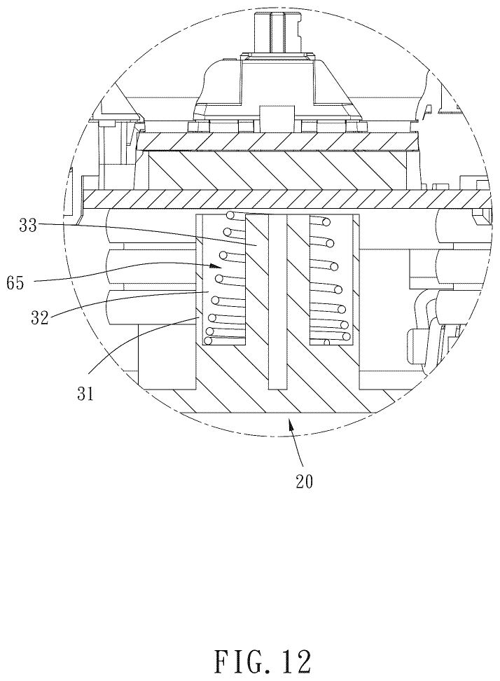

It is worth mentioning that the special-shaped buffer element 64 and the conical spring 65 can be assembled with the base 20 in different ways. For example, as shown in FIGS. 9-10, the base 20 further has an upright column 31 connected to the bottom wall 21 and provided with a receiving trough 32 with an upward-facing opening. The special-shaped buffer element 64 (or the conical spring 65) is installed in the receiving trough 32 and uses its top and bottom ends to abut against the bottom surface of the printed circuit board assembly 41 and the bottom surface 322 of the receiving trough 32, respectively, for providing a buffering effect. Alternatively, as shown in FIGS. 11-12, a central column 33 extends upwards from the bottom surface 322 of the receiving trough 32. The central column 33 is coaxial with the upright column 31 and penetrated into the special-shaped buffer element 64 (or the conical spring 65) for providing a positioning effect to the special-shaped buffer element 64 (or the conical spring 65).

On the other side, the printed circuit board assembly 41, the buffer pad 42, and the support plate 43 can further be fixed together by using another special-shaped buffer element 70. In order to match the different fixing ways of the special-shaped buffer element 70, the relevant components will have different structural changes.

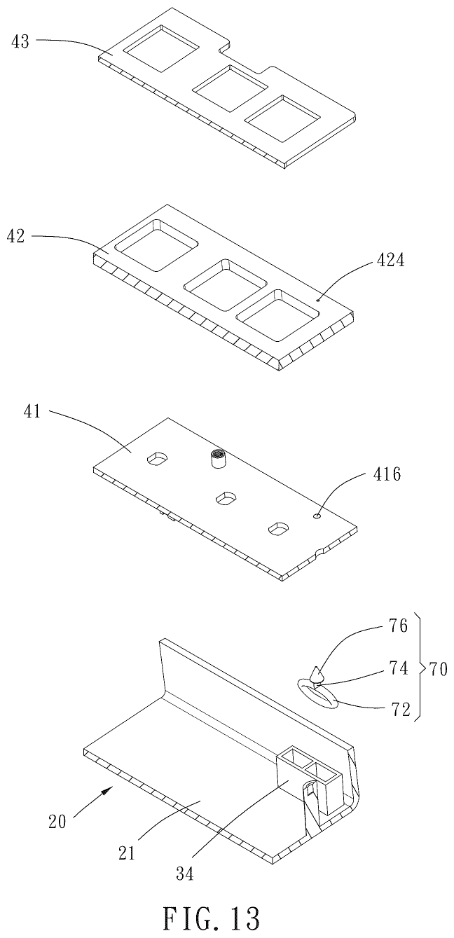

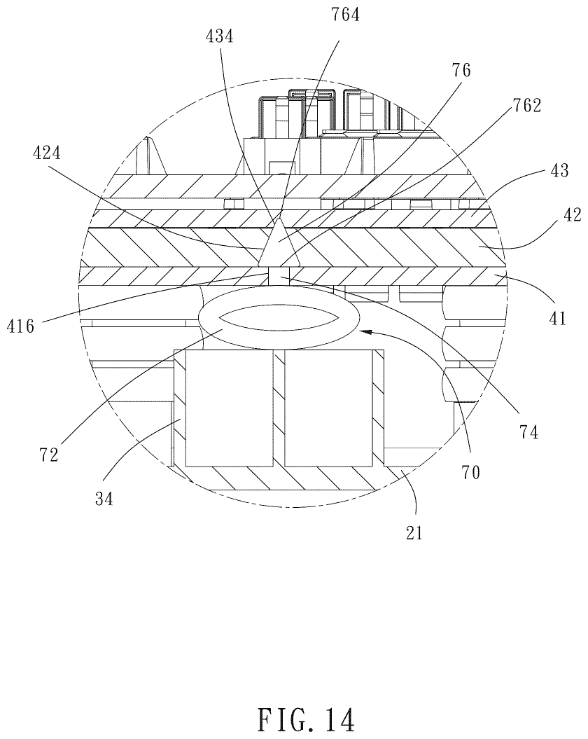

As shown in FIGS. 13-14, the base 20 has a support column 34 connected to the bottom wall 21. The support plate 43 has an insertion hole 434, and the buffer pad 42 has a middle through hole 424, and the printed circuit board assembly 41 has a lower through hole 416. The special-shaped buffer element 70 has an oval ring portion 72 simultaneously abutted against the bottom surface of the printed circuit board assembly 41 and the top end of the support column 34, a rod portion 74 inserted into the lower through hole 416 and having one end connected to the oval ring portion 72, and a cone portion 76 inserted into the middle through hole 424 and having a blunt end 762 connected to the rod portion 74 and a pointed end 764 inserted into the insertion hole 434. In this way, the special-shaped buffer element 70 fixes the printed circuit board assembly 41, the buffer pad 42, and the support plate 43 together from bottom to top for providing support and buffering effects.

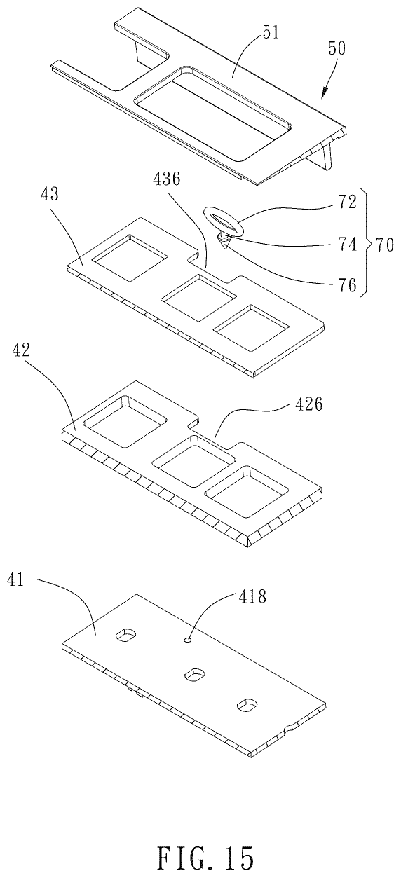

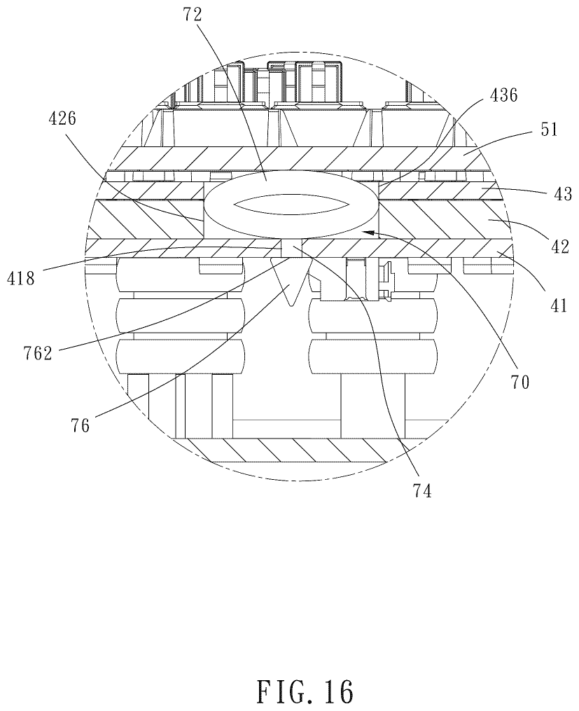

Alternatively, as shown in FIGS. 15-16, the support plate 43 has an upper notch 436, and the buffer pad 42 has a middle notch 426, and the printed circuit board assembly 41 has a lower through hole 418. The oval ring portion 72 of the special-shaped buffer element 70 is received in the upper and middle notches 436, 426 and simultaneously abutted against the bottom surface of the top plate 51 and the top surface of the printed circuit board assembly 41. The rod portion 74 of the special-shaped buffer element 70 is inserted into the lower through hole 418. The cone portion 76 of the special-shaped buffer element 70 protrudes out of the bottom surface of the printed circuit board assembly 41 and uses the blunt end 762 to abut against the bottom surface of the printed circuit board assembly 41. In this way, the special-shaped buffer element 70 fixes the printed circuit board assembly 41, the buffer pad 42, and the support plate 43 together from top to bottom for providing support and buffering effects.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A keyboard comprising:
a base having a bottom wall and an inner periphery wall connected to an outer periphery of the bottom wall to form an accommodation space with the bottom wall;
a key module disposed in the accommodation space of the base and having a printed circuit board assembly and a plurality of keys connected to the printed circuit board assembly;
a top cover mounted on the base and having a plurality of hollow areas to expose the keys; and
a buffer unit disposed in the accommodation space of the base and including a cantilever having a support portion connected to a bottom surface of the printed circuit board assembly, an inclined extension arm having a top end connected to the support portion, and a shaft portion connected to a bottom end of the inclined extension arm and spaced from the bottom wall of the base, and a torsion spring sleeved on the shaft portion and having two end portions abutted against the bottom wall of the base and the inner periphery wall of the base, respectively.

2. The keyboard as claimed in claim 1, wherein the base further includes a stand plate connected to a top surface of the bottom wall, and a shaft portion connected to one lateral side of the stand plate; the buffer unit further includes another torsion spring sleeved on the shaft portion of the base and having two end portions abutted against the bottom wall of the base and the bottom surface of the printed circuit board assembly, respectively.

3. The keyboard as claimed in claim 1, wherein the key module further includes a buffer pad disposed on a top surface of the printed circuit board assembly and having a plurality of lower positioning holes, and a support plate disposed on a top surface of the buffer pad and having a plurality of upper positioning holes; the keys are positioned into the upper and lower positioning holes.

4. The keyboard as claimed in claim 3, wherein the support plate, the buffer pad, and the printed circuit board assembly are fixed together though a special-shaped buffer element.

5. The keyboard as claimed in claim 4, wherein the base has a support column connected to the bottom wall; the special-shaped buffer element has an oval ring portion abutted against the bottom surface of the printed circuit board assembly and a top end of the support column, a rod portion inserted into a lower through hole of the printed circuit board assembly and having one end connected to the oval ring portion, and a cone portion inserted into a middle through hole of the buffer pad and having a blunt end connected to the rod portion and a pointed end inserted into an insertion hole of the support plate.

6. The keyboard as claimed in claim 4, wherein the special-shaped buffer element has an oval ring portion received in an upper notch of the support plate and a middle notch of the buffer pad and abutted against a bottom surface of the top cover and the top surface of the printed circuit board assembly, a rod portion inserted into a lower through hole of the printed circuit board assembly and having one end connected to the oval ring portion, and a cone portion protruding out of the bottom surface of the printed circuit board assembly and having a blunt end connected to the rod portion and abutted against the bottom surface of the printed circuit board assembly.

7. The keyboard as claimed in claim 1, wherein the base has a fixed column connected to the bottom wall; the printed circuit board assembly is screwed to the base by using a screw inserted into a fixed hole of the printed circuit board assembly and screwed to a screw hole of the fixed column of the base.

8. The keyboard as claimed in claim 7, wherein the base further has a plurality of wings connected to the fixed column and the bottom wall and arranged in a spaced manner relative to the fixed column; a conical spring is sleeved on the fixed column and provided with top and bottom ends abutted against the bottom surface of the printed circuit board assembly and the wings, respectively; the conical spring has a diameter increasing gradually from the printed circuit board assembly to the bottom wall.

9. The keyboard as claimed in claim 7, wherein the base further has a plurality of wings connected to the fixed column and the bottom wall and arranged in a spaced manner relative to the fixed column; a special-shaped buffer element is sleeved on the fixed column and provided with top and bottom ends abutted against the bottom surface of the printed circuit board assembly and the wings, respectively.

10. The keyboard as claimed in claim 9, wherein the special-shaped buffer element is a hollow cylinder with a plurality of annular folds arranged at intervals on an outer surface thereof.

11. The keyboard as claimed in claim 1, wherein the base has an upright column with a bottom end connected to the bottom wall; a conical spring is disposed in a receiving trough of the upright column of the base and has top and bottom ends abutted against the bottom surface of the printed circuit board assembly and a bottom surface of the receiving trough, respectively.

12. The keyboard as claimed in claim 11, wherein a central column extends upwards from the bottom surface of the receiving trough, and the central column is coaxial with the upright column and penetrated into the conical spring.

13. The keyboard as claimed in claim 1, wherein the base has an upright column with a bottom end connected to the bottom wall; a special-shaped buffer element is disposed in a receiving trough of the upright column of the base and has top and bottom ends abutted against the bottom surface of the printed circuit board assembly and a bottom surface of the receiving trough, respectively.

14. The keyboard as claimed in claim 13, wherein a central column extends upwards from the bottom surface of the receiving trough, and the central column is coaxial with the upright column and penetrated into the special-shaped buffer element.

15. The keyboard as claimed in claim 13, wherein the special-shaped buffer element is a hollow cylinder with a plurality of annular folds arranged at intervals on an outer surface thereof.
